(19) United States
(12) Patent Application Publication
(10) Pub. No.: US 2026/0122688 A1
(43) Pub. Date: Apr. 30, 2026

(54) L1/L2-BASED TIMING ACQUISITION AND HANDOVER

(71) Applicant: Apple Inc., Cupertino, CA (US)

(72) Inventors: Hong He, San Jose, CA (US); Dawei Zhang, Saratoga, CA (US); Wei Zeng, Saratoga, CA (US); Haitong Sun, Cupertino, CA (US); Chunhai Yao, Beijing (CN); Chunxuan Ye, San Diego, CA (US); Weidong Yang, San Diego, CA (US); Sigen Ye, Whitehouse Station, NJ (US); Seyed Ali Akbar Fakoorian, San Diego, CA (US); Jie Cui, San Jose, CA (US)

(21) Appl. No.: 19/116,942

(22) PCT Filed: Sep. 29, 2022
(86) PCT No.: PCT/CN2022/122385

§ 371 Date: Mar. 28, 2025

(51) Int. Cl. H04W 74/0833; H04W 72/23; H04W 76/27

(52) U.S. Cl. CPC H04W 74/0833; H04W 72/23; H04W 76/27

(57) ABSTRACT

A user equipment (UE) includes a set of transceivers and a processor. The processor is configured to operate the UE in an RRC_CONNECTED mode with a first TRP; receive, via the set of transceivers, a PDCCH order in a search space set associated with at least one of the first TRP or a second TRP; determine, in response to information indicated by the PDCCH order, a PRACH resource to be used for a RACH procedure with the second TRP; and transmit, via the set of transceivers, a RACH preamble on the PRACH resource to acquire an initial timing advance (TA) toward the second TRP.

### TECHNICAL FIELD

This application relates generally to wireless communications systems, including timing acquisition and handover.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows an example wireless communications system including a UE, a first transmission and reception point (TRP), and a second TRP.

FIG. 2 shows a first example method of wireless communication by a UE.

FIG. 3 shows an example timing diagram of a physical downlink control channel (PDCCH) order transmission, in accordance with an intra-cell mTRP embodiment of the method shown in FIG. 2.

FIG. 4 shows an example of an enhanced PDCCH order downlink control information (DCI) format for triggering an inter-cell multiple TRP (mTRP) random access channel (RACH) procedure.

FIG. 5 shows another example timing diagram of a PDCCH order transmission, in accordance with some embodiments of the method shown in FIG. 2.

FIG. 6 shows a second example method of wireless communication by a UE.

FIG. 7 shows a third example method of wireless communication by a UE.

FIG. 8 shows an example abstract syntax notation one (ASN.1) message for physical cell ID (PCI)-based pre-configuration of target candidate cells for L1/L2-based handover.

FIG. 9 shows an example cell group-based pre-configuration of target candidate cells for L1/L2-based handover.

FIG. 10 shows an example medium access control (IAC) control element (CE) (IAC CE) for triggering L1/L2-based handover.

FIG. 11 shows an example DCI format for triggering L1/L2-based handover.

FIG. 12 shows a first example method of wireless communication by a base station.

FIG. 13 shows a second example method of wireless communication by a base station.

FIG. 14 shows a third example method of wireless communication by a base station.

FIG. 15 illustrates an example architecture of a wireless communication system, according to embodiments disclosed herein.

FIG. 16 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with a network. Therefore, the UE as described herein is used to represent any appropriate electronic device.

New mobile services that require low-latency and high reliability performance (e.g., ultra-reliable and low-latency communications (URLLC)) are emerging. While 5G 3GPP standards have been designed to address these services from the start, the evolution of 5G RAT needs to continuously enhance the mobility robustness performance for these challenging scenarios.

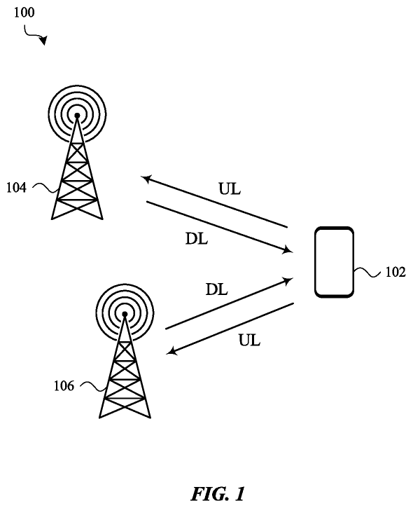

FIG. 1 shows an example wireless communications system 100 including a UE 102, a first TRP 104, and a second TRP 106. The UE 102 may communicate with one or more of the first TRP 104 or second TRP 106 on a downlink (DL) and an uplink (UL). In various embodiments, the UE 102 may communicate with the first TRP 104, the second TRP 106, or both the first TRP 104 and second TRP 106 (e.g., in a mTRP scenario). Each TRP may be a macro-cell, a small cell, a pico-cell, a femto-cell, a remote radio head, a relay node, etc. One or more of the UE 102, the first TRP 104, or the second TRP 106 may use multiple-input and multiple-output (MIMO) communication techniques.

In some scenarios, the UE 102, first TRP 104, or second TRP 106 may have multiple antenna panels, and the antenna panels may be used for simultaneous or contemporaneous alternate communication with both the first TRP 104 and the second TRP 106.

In some cases, the UE 102 may communicate with the first and second TRPs 104, 106 in a mTRP scenario, or may communicate in a single TRP or mTRP scenario using MIMO communication techniques. In some cases, the UE 102 may be handed over from the first TRP 104 to the second TRP 106, or vice versa.

In some embodiments, the UE 102 may simultaneously or contemporaneously communicate with additional TRPs (e.g., a third TRP). The first TRP 104, second TRP 106, or other TRPs may also simultaneously or contemporaneously communicate with other UEs.

In a wireless communications system such as the wireless communications system described with reference to FIG. 1, it may be desirable for a UE to acquire an initial timing advance (TA) of a second (or additional) TRP. The initial TA may be used, for example, when the UE will operate in a mTRP scenario that involves the second TRP, or when the UE will be handed over to the second TRP. A procedure to trigger a RACH procedure by the UE, to obtain an initial TA toward the second mTRP, may therefore be useful.

Also in a wireless communications system such as the wireless communications system described with reference to FIG. 1, it may be desirable to reduce inter-cell mobility latency. As described herein, inter-cell mobility latency may be reduced by providing a UE with pre-configurations for target candidate cells (i.e., providing the pre-configurations prior to issuing an L1/L2 handover command), such that latency can be reduced for L1/L2 based handover.

Also described herein are example inter-cell L1/L2 handover trigger commands. In current 3GPP standard releases, handover commands are carried in layer 3 (L3) radio resource control (RRC) messages. In some cases, the L1/L2 handover trigger commands described herein are integrated with triggers related to inter-cell mTRP beam management (e.g., RACH procedure triggers).

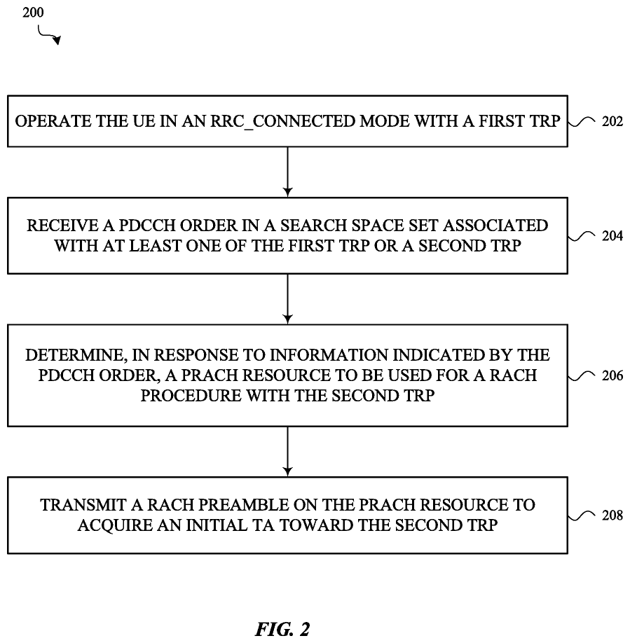

FIG. 2 shows a first example method 200 of wireless communication by a UE. The method 200 may be performed by the UE described with reference to FIG. 1 or by other UEs described herein. The method 200 may be performed using a processor, a set of transceivers (e.g., one or more transceivers), or other components of a UE.

At 202, the method 200 may include operating the UE in an RRC_CONNECTED mode with a first TRP (e.g., TRP #1).

At 204, the method 200 may include receiving a PDCCH order (i.e., DCI format 1_0). The PDCCH order may be received in a search space set associated with at least one of the first TRP or a second TRP (e.g., TRP #2).

At 206, the method 200 may include determining, in response to information indicated by the PDCCH order, a PRACH resource to be used for a RACH procedure with the second TRP. The PDCCH order therefore includes information that may be used to trigger the RACH procedure. The RACH procedure may be a contention-free RACH (CFRA) procedure or a contention-based RACH (CBRA) procedure that is triggered by the PDCCH order.

At 208, the method 200 may include transmitting a RACH preamble on the PRACH resource to acquire an initial TA toward the second TRP.

The method 200 may be variously embodied, extended, or adapted, as described in the following paragraphs and elsewhere in this description.

In some embodiments, the method 200 may be implemented as a method for cross-TRP RACH procedure triggering by PDCCH order, because a PDCCH order transmitted by one TRP (i.e., the first TRP) may trigger a RACH procedure with respect to another TRP (i.e., the second TRP). Various cross-TRP RACH procedure triggering by PDCCH order embodiments are described below.

In some embodiments of the method 200, the first TRP and the second TRP may share a PCI (e.g., an intra-cell mTRP scenario). In these embodiments, the PDCCH order may be received, at 204, in a search space set associated with the first TRP (e.g., in a search space set with ‘coresetPoolIndex=0’). The information indicated by the PDCCH order may include a synchronization signal block (SSB) index and a random access (RA) preamble index that is associated with an SSB identified by the SSB index. For a scenario in which the PRACH resource determined at 206 is to be used for a CBRA procedure, the UE may receive (e.g., from the first TRP and before receiving the PDCCH order) a number of SSBs associated with the first TRP and the second TRP for each PRACH occasion, and a number of contention-based preambles per SSB. The SSB index may then be used to identify a contention-based preamble of the number of contention-based preambles, for the SSB identified by the SSB index. For a scenario in which the PRACH resource determined at 206 is to be used for a CFRA procedure, the UE may dynamically select the PRACH resource in response to the information indicated by the PDCCH order (e.g., the SSB index and the RA preamble index).

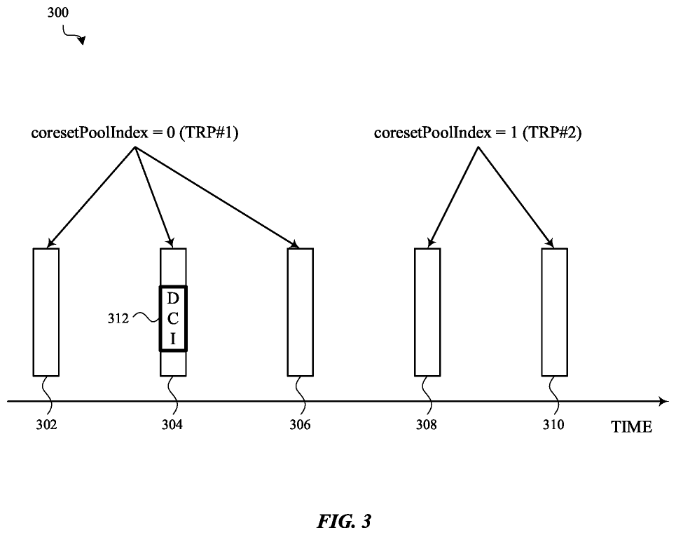

FIG. 3 shows an example timing diagram 300 of a PDCCH order transmission, in accordance with an intra-cell mTRP embodiment of the method shown in FIG. 2 (in which a first TRP and a second TRP have a same PCI). The timing diagram assumes that a UE is in an RRC_CONNECTED mode with the first TRP.

As shown, a first search space set (e.g., ‘coresetPoolIndex=0’) of the first TRP (e.g., the first TRP shown in FIG. 1, or TRP #1) may include search spaces 302, 304, and 306. A second search space set (e.g., ‘coresetPoolIndex=1’) of the second TRP (e.g., the second TRP shown in FIG. 1, or TRP #2) may include search spaces 308 and 310. A first set of SSBs (e.g., SSB #1, #2, and #3) may be associated with the first search space set (i.e., ‘coresetPoolIndex=0’), and a second set of SSBs (e.g., SSB #4, #5, and #6) may be associated with the second search space set (i.e., ‘coresetPoolIndex=1’).

As also shown, a base station (e.g., a gNB) may transmit a PDCCH order 312 (i.e., DCI format 1_0) in search space 304 of the first TRP. Upon receiving the PDCCH order, the UE may determine, for example, that the PDCCH order indicates <SSB #4, Preamble 6>. Upon receiving this DCI, the UE may transmit Preamble 6 associated with SSB #4 to acquire the initial TA toward the second TRP.

Returning to FIG. 2, and in some embodiments of the method 200, the first TRP and the second TRP may be associated with different PCIs (e.g., an inter-cell mTRP scenario). In these embodiments, the PDCCH order may be received in a search space set associated with the first TRP (e.g., in a search space set with ‘coresetPoolIndex=0’). The information indicated by the PDCCH order may identify a TRP associated with a triggered RACH procedure (e.g., the information may include a PCI of the second TRP). The UE may receive (e.g., from the first TRP and before receiving the PDCCH order) a PRACH resource configuration of each non-serving cell in an ‘additionalPCIlist’, where each non-serving cell in the ‘additionalPCIlist’ is configured with an ‘additional PCI’ index in the ‘additionalPCIlist’. The PDCCH order may identify a non-serving cell in the ‘additionalPCIlist’ by its ‘additional PCI’ index. The TRP identified by the PDCCH order may be identified in different ways, some examples of which are described below.

A PDCCH order includes a set of fields. In some cases, the set of fields may be enhanced to include a field that identifies the TRP associated with the triggered RACH procedure (e.g., the second TRP in FIG. 2). In 3GPP Release 17 (Rel-17), a PCI for a UE's serving cell and up to seven additional PCIs can be configured by RRC signaling for multiple DCI (mDCI) mTRP operation of a UE. However, only one PCI of the seven additional PCIs can be associated with a set of active TCI states for the UE (e.g., an active TCI state for the second TRP in FIG. 2), and the remaining PCIs are not associated with the set of active TCI states. As a result, and in some embodiments, the PDCCH order may be enhanced to include a one-bit field that identifies a TRP associated with a triggered RACH procedure. The one-bit field may identify the TRP as the serving cell of the UE (e.g., for resynchronization purposes) or as the non-serving cell associated with the set of active TCI states. For example, when the one-bit field is set to ‘0’, the field may indicate that the triggered RACH procedure is for the UE's serving cell; and when the one-bit field is set to ‘1’, the field may indicate that the triggered RACH procedure is for the non-serving cell associated with the set of active TCI states (e.g., a non-serving cell associated with the second TRP). In other embodiments, the PDCCH order may be enhanced to include a three-bit field that identifies a TRP associated with a triggered RACH procedure. The three-bit field may identify the TRP as the serving cell of the UE (e.g., for resynchronization purposes) or any one of the seven non-serving cells configured by RRC signaling for mDCI mTRP operation of the UE (e.g., any non-serving cell for the second TRP in FIG. 2). In this manner, an initial TA may be acquired for a TRP (e.g., the second TRP) before the TRP is activated.

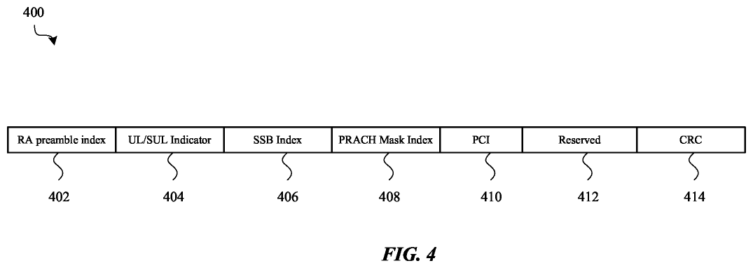

FIG. 4 shows an example of an enhanced PDCCH order DCI format 400 for triggering an inter-cell mTRP RACH procedure. The PDCCH order DCI format 400 (e.g., an enhanced DCI format 1_0) may include a set of fields including an RA preamble index field 402, a normal UL or supplementary UL (SUL) (UL/SUL) indicator field 404, an SSB index field 406, a PRACH mask index field 408, a PCI field 410, one or more reserved bits 412, and/or a cyclic redundancy check (CRC) field 414.

As previously described, the PCI field 410 may be a one-bit field or a three-bit field. When the PCI field 410 is a three-bit field (e.g., a three-bit field that indicates an ‘additional PCI’ index value), one example interpretation of the three-bits is shown in Table 1:

TABLE 1

| Value of | |
|---|---|
| PCI field | Description |
| ‘000’ | RACH procedure is triggered for serving cell |
| ‘001’ | RACH procedure is triggered for non-serving cell associated |
| | with 1^{st} additional PCI configured by RRC |
| ‘010’ | RACH procedure is triggered for non-serving cell associated |
| | with 2^{nd} additional PCI configured by RRC |
| ‘011’ | RACH procedure is triggered for non-serving cell associated |
| | with 3^{rd} additional PCI configured by RRC |
| . . . | . . . |
| ‘111’ | RACH procedure is triggered for non-serving cell associated |
| | with 7^{th} additional PCI configured by RRC |

In some embodiments, the method 200 may be implemented as a method for TRP-specific RACH procedure triggering by PDCCH order, because a PDCCH order transmitted by one TRP (i.e., the second TRP) may trigger a RACH procedure for the same TRP (i.e., the second TRP). Separate PRACH resources may be configured per SSB index for each search space set. In these embodiments, the PDCCH order may be received, at 204, in a search space set associated with the second TRP (e.g., in a search space set with ‘coresetPoolIndex=0’). More generally, a PDCCH order received in a search space set with ‘coresetPoolIndex=i’; where (i=0,1), may be used to trigger a RACH procedure toward the corresponding TRP associated with ‘coresetPoolIndex=i’. The information indicated by the PDCCH order may include a SSB index and a RA preamble index, as previously described. In some embodiments, the UE may receive, from the first TRP, before receiving the PDCCH order, and for each non-serving cell that is configured in an ‘additionalPCIlist’: a Type1-PDCCH common search space (CSS) set configuration; and a random access response (RAR) window configuration. After transmitting the RACH preamble at 208, the UE may monitor a Type1-PDCCH CSS set associated with the second TRP for a RAR, in accordance with a Type1-PDCCH CSS set configuration for the second TRP, and in accordance with a RAR window configuration for the second TRP.

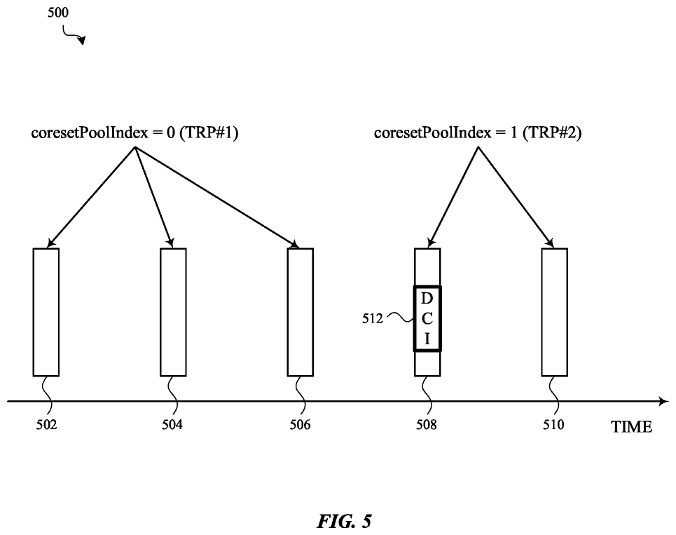

FIG. 5 shows another example timing diagram 500 of PDCCH order transmission, in accordance with some embodiments of the method shown in FIG. 2. The timing diagram assumes that a UE is in an RRC_CONNECTED mode with the first TRP.

As shown, a first search space set (e.g., ‘coresetPoolIndex=0’) of the first TRP (e.g., the first TRP shown in FIG. 1, or TRP #1) may include search spaces 502, 504, and 506. A second search space set (e.g., ‘coresetPoolIndex=1’) of the second TRP (e.g., the second TRP shown in FIG. 1, or TRP #2) may include search spaces 508 and 510. A first set of SSBs (e.g., SSB #1, #2, and #3) may be associated with the first search space set (i.e., ‘coresetPoolIndex=0’), and a second set of SSBs (e.g., SSB #4, #5, and #6) may be associated with the second search space set (i.e., ‘coresetPoolIndex=1’).

As also shown, a base station (e.g., a gNB) may transmit a PDCCH order 512 (i.e., DCI format 1_0) in search space 508 of the second TRP. Upon receiving the PDCCH order, the UE may determine, for example, that the PDCCH order indicates <SSB #4, Preamble 6>. Upon receiving this DCI, the UE may transmit Preamble 6 associated with SSB #4 to acquire the initial TA toward the second TRP.

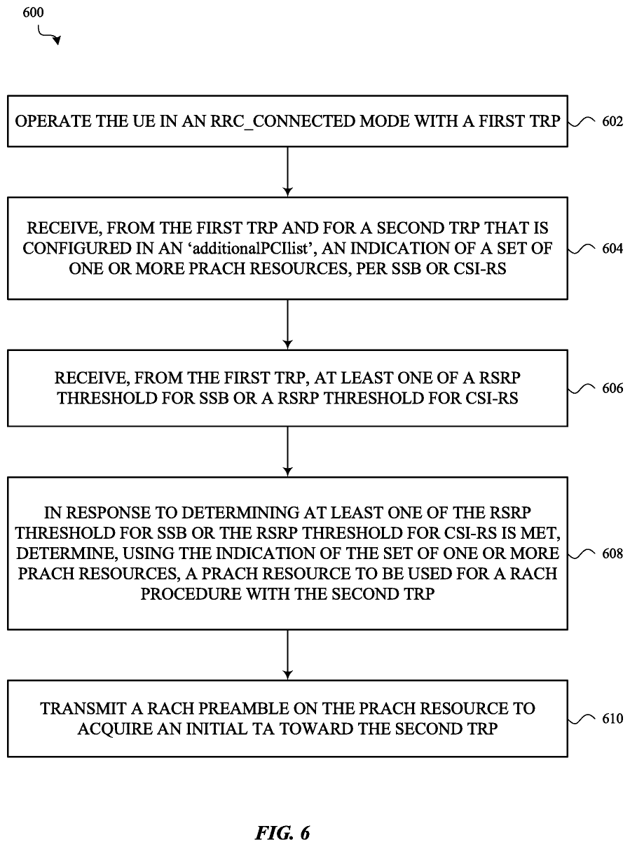

FIG. 6 shows a second example method 600 of wireless communication by a UE. The method 600 may be performed by the UE described with reference to FIG. 1 or by other UEs described herein. The method 600 may be performed using a processor, a set of transceivers (e.g., one or more transceivers), or other components of a UE.

At 602, the method 600 may include operating the UE in an RRC_CONNECTED mode with a first TRP (e.g., TRP #1).

At 604, the method 600 may include receiving, from the first TRP and for a second TRP that is configured in an ‘additionalPCIlist’, an indication of a set of one or more PRACH resources. The PRACH resources may be indicated per SSB or channel state information reference signal (CSI-RS).

At 606, the method 600 may include receiving, from the first TRP, at least one of a reference signal received power (RSRP) threshold for SSB or a RSRP threshold for CSI-RS.

At 608, the method 600 may include, in response to determining at least one of the RSRP threshold for SSB or the RSRP threshold for CSI-RS is met, determining, using the indication of the set of one or more PRACH resources, a PRACH resource to be used for a RACH procedure with the second TRP. The RACH procedure may be a CFRA procedure or a CBRA procedure.

At 610, the method 600 may include transmitting a RACH preamble on the PRACH resource to acquire an initial TA toward the second TRP.

Because the RACH procedure is based at least partly on the UE's determination that the RSRP threshold for SSB or the RSRP threshold for CSI-RS is met, the method 600 is considered a UE-triggered method.

In some embodiments of the method 600, the UE may receive, from the first TRP and for the second TRP, a Type1-PDCCH CSS set configuration and a RAR window configuration. After transmitting the RACH preamble at 608, the UE may monitor a Type1-PDCCH CSS set associated with the second TRP for a RAR, in accordance with a Type1-PDCCH CSS set configuration for the second TRP, and in accordance with a RAR window configuration for the second TRP.

The method 600 may be variously embodied, extended, or adapted, as described in the following paragraphs and elsewhere in this description.

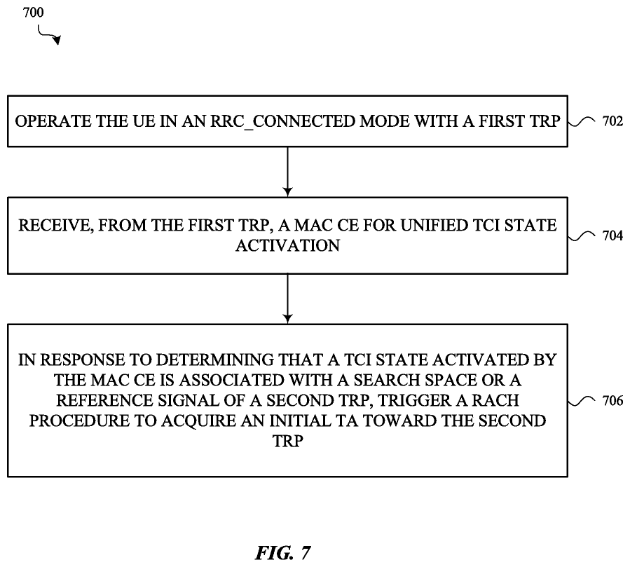

FIG. 7 shows a third example method 700 of wireless communication by a UE. The method 700 may be performed by the UE described with reference to FIG. 1 or by other UEs described herein. The method 700 may be performed using a processor, a set of transceivers (e.g., one or more transceivers), or other components of a UE.

At 702, the method 700 may include operating the UE in an RRC_CONNECTED mode with a first TRP (e.g., TRP #1).

At 704, the method 700 may include receiving, from the first TRP, a MAC CE for unified TCI state activation.

At 706, the method 700 may include, in response to determining that a TCI state activated by the MAC CE is associated with a search space or a reference signal (e.g., a quasi co-location (QCL) source reference signal (RS)) of a second TRP, triggering a RACH procedure to acquire an initial TA toward the second TRP.

The method 700 may be variously embodied, extended, or adapted, as described in the following paragraphs and elsewhere in this description.

As previously mentioned, inter-cell mobility latency may be reduced by providing a UE with pre-configurations for target candidate cells (i.e., providing the pre-configurations prior to issuing an L1/L2 handover command), such that latency can be reduced for L1/L2-based handover.

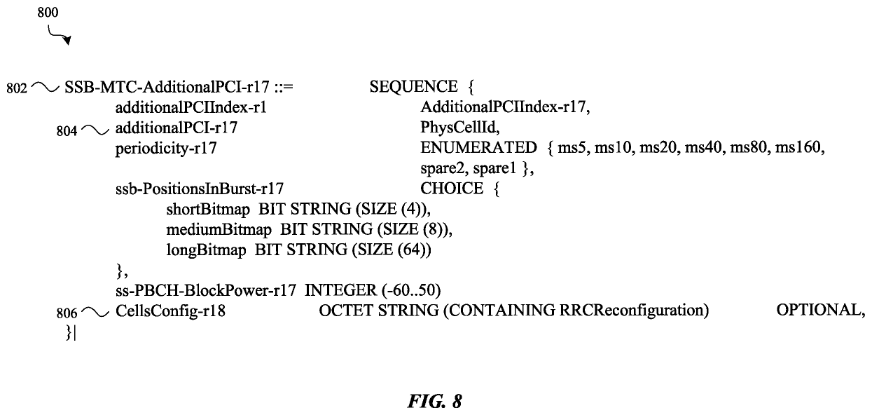

FIG. 8 shows an example ASN.1 message 800 for PCI-based pre-configuration of target candidate cells for L1/L2-based handover. The message 800 may be transmitted to a UE, and received by the UE, from a TRP with which the UE is in an RRC_CONNECTED mode. The message may be received by the UE before the TRP transmits, to the UE, a handover command targeting a non-serving cell (or neighbor cell) in an ‘additionalPCIlist’. As shown, a list of neighbor cell PCIs may be provided to the UE in an ‘additionalPCI-r17’ information element (IE) 804 of an ‘SSB-MTC-AdditionalPCI-r17’ IE (as in 3GPP Rel-170) 802. However, the ‘SSB-MTC-AdditionalPCI-r17’ IE 802 may be enhanced to include an RRC configuration for one or more (or each) neighbor cell listed in the ‘additionalPCI-r17’ IE 804. For example, the ‘SSB-MTC-AdditionalPCI-r17’ IE 802 may be enhanced to include a cell configuration IE 806 (e.g., a ‘CellConfig-r18’ IE). The cell configuration IE 806 may include the RRC configuration(s) for one or more (or each) of the neighbor cells listed in the ‘additionalPCI-r17’ IE 804. For purposes of this description, ‘additionalPCI-r17’ is an example of a PCI list (i.e., an example of ‘additionalPCIlist’.

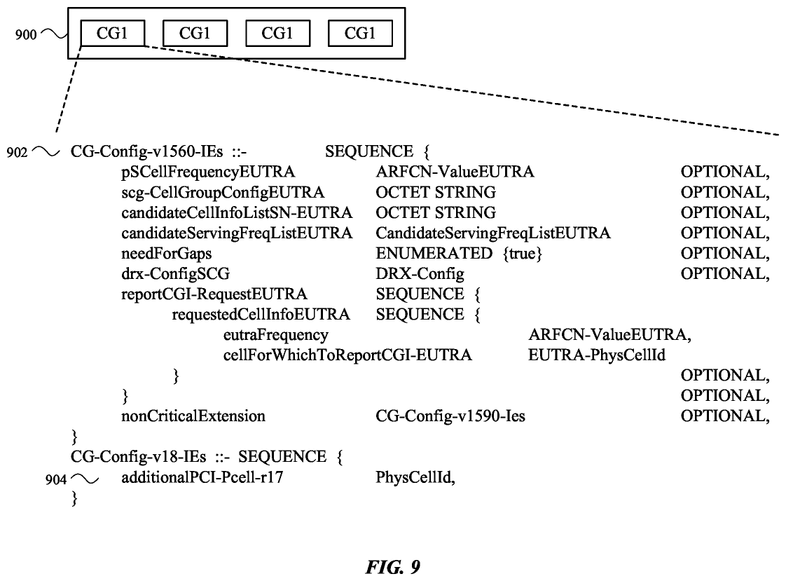

FIG. 9 shows an example cell group (CG)-based pre-configuration of target candidate cells for L1/L2-based handover. In accordance with the CG-based pre-configuration, a TRP with which a UE is in an RRC_CONNECTED mode may transmit, to the UE, an RRC configuration including a list of CGs 900 (e.g., CG1, CG2, CG3, and CG4). The RRC configuration may also include a configuration 902 of a target candidate cell for L1/L2-based handover, and an indicator 904 of the target candidate cell (e.g., an indicator of a primary serving cell (PCell) or a primary and secondary serving cell (PSCell)).

The CG-based pre-configuration of target candidate cells for L1/L2-based handover may in some cases reduce overhead, in that the configuration 902 may be provided for a group of cells (or component carriers (CCs))—in contrast to the PCI-based pre-configuration of target candidate cells for L1/L2-based handover, which includes a configuration per target candidate cell (or CC).

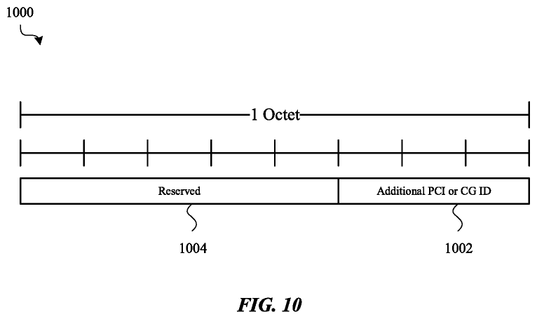

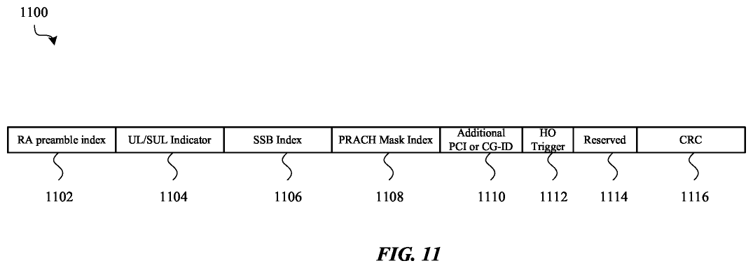

FIGS. 10 and 11 illustrate examples of inter-cell L1/L2 handover trigger commands. FIG. 10 shows an example MAC CE 1000 for triggering L1/L2-based handover. The MAC CE 1000 may be a new MAC CE, introduced for the purpose of triggering L1/L2-based handover (and particularly, an L2-based handover) to a target cell. The MAC CE 1000 may be identified by a MAC subheader with a dedicated logical channel ID (LCID).

In some cases, the MAC CE 1000 may have a fixed size and consist of a single octet of bits. The MAC CE 1000 (or octet) may include, for example, an additional PCI or CG-ID field 1002. The additional PCI or CG-ID field 1002 may include a PCI or CG-ID associated with the target cell. The additional PCI or CG-ID field 1002 may include a PCI or CG-ID associated with the target cell. In some cases, the PCI or CG-ID field 1002 may be a three-bit field. The MAC CE 1000 may also include reserved bits 1004. In some cases, the reserved bits 1004 may be set to ‘0’.

In some cases, the PCI or CG-ID field 1002 may be a three-bit field. In some cases, the reserved bits 1004 may be set to ‘0’.

In some embodiments, the MAC CE 1000 may include an additional field for CG-based signaling. For example, the MAC CE 1000 may include a field to indicate which cell of a CG is used as the PCell or PSCell after L1/L2 handover.

FIG. 11 shows an example DCI format 1100 for triggering L1/L2-based handover (and particularly, an L1-based handover) to a target cell. In some embodiments, the DCI format 1100 may be an enhanced DCI format 1_0, and may be used to trigger L1/L2-based handover and/or a RACH procedure. The DCI format 1100 may include an RA preamble index field 1102, an UL/SUL indicator field 1104, an SSB index field 1106, a PRACH mask index field 1108, an additional PCI or CG-ID field 1110, a handover (HO) trigger field 1112, one or more reserved bits 1114, and/or a CRC field 1116. The additional PCI or CG-ID field 1110 may include a PCI or CG-ID associated with the target cell. In some cases, the additional PCI or CG-ID field 1110 may be a three-bit field. The handover trigger field 1112 may indicate whether one or both of a L1/L2-based handover or a RACH procedure is triggered for a PCI or CG-ID identified in the additional PCI or CG-ID field 1110 (i.e., the handover trigger field 1112 may be used to differentiate between L1/L2 inter-cell handover and inter-cell beam management (e.g., initial TA acquisition)). In some cases, the reserved bits 1004 may be set to ‘0’.

In some cases, the handover trigger field 1112 may be a N-bit field (e.g., an N=2 bit field). Table 2 shows example interpretations of various 2-bit values of the handover trigger field 1112:

TABLE 2

| Value of | | |
|---|---|---|
| ‘HO trigger | | |
| field’ | Description | Use Case |
| ‘00’ | PRACH is triggered and | Inter-cell mTRP |
| | L1/L2 HO is NOT triggered | without HO use case |
| ‘01’ | PRACH is triggered and | Inter-cell L1/L2 HO |
| | L1/L2 HO is triggered | (mobility) use case |
| ‘10’ | PRACH is NOT triggered and | Inter-cell L1/L2 HO |
| | L1/L2 HO is triggered with | (mobility) with RACH- |
| | TA value of ‘0’ | less operation |
| ‘11’ | PRACH is NOT triggered and | Inter-cell L1/L2 HO |
| | L1/L2 HO is triggered with | (mobility) with RACH-less |
| | TA value of one serving cell | operation (e.g., the target |
| | | PCell is in a same timing |
| | | advance group (TAG) of |
| | | one SCell |

For both MAC CE-based and DCI-based triggering of L1/L2-based handover to a target cell, upon receiving the MAC CE or DCI, the UE may start applying a pre-configured target cell configuration, in accordance with the pre-configuration described with reference to FIG. 8 or 9.

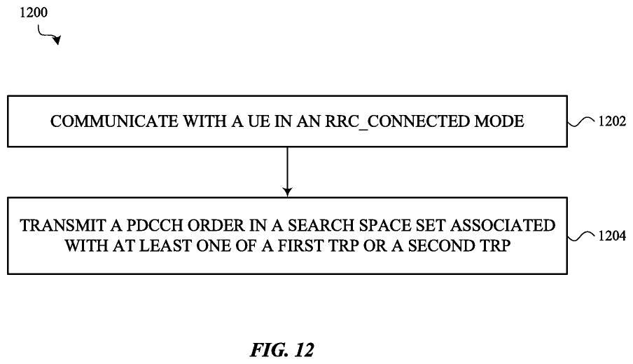

FIG. 12 shows a first example method 1200 of wireless communication by a base station. The method 1200 may be performed by the first TRP described with reference to FIG. 1 or by other TRPs described herein. The method 1200 may be performed using a processor, a set of transceivers (e.g., one or more transceivers), or other components of a base station.

At 1202, the method 1200 may include communicating with a UE in an RRC_CONNECTED mode.

At 1204, the method 1200 may include transmitting a PDCCH order (i.e., DCI format 1_0). The PDCCH order may be transmitted in a search space set associated with at least one of the base station (or first TRP (TRP #1)) or a second TRP (e.g., TRP #2).

The method 1200 may be variously embodied, extended, or adapted, as described elsewhere in this description.

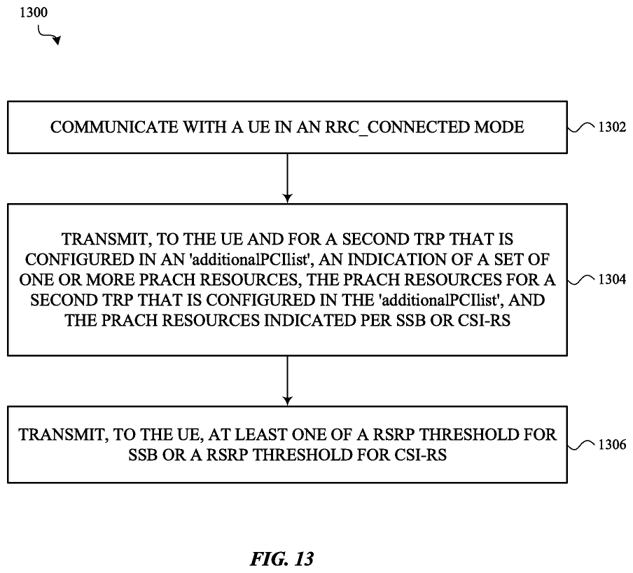

FIG. 13 shows a second example method 1300 of wireless communication by a base station. The method 1300 may be performed by the first TRP described with reference to FIG. 1 or by other TRPs described herein. The method 1300 may be performed using a processor, a set of transceivers (e.g., one or more transceivers), or other components of a base station.

At 1302, the method 1300 may include communicating with a UE in an RRC_CONNECTED mode.

At 1304, the method 1300 may include transmitting, to the UE, and for a second TRP that is configured in an ‘additionalPCIlist’, an indication of a set of one or more PRACH resources. The PRACH resources may be for a second TRP that is configured in the ‘additionalPCIlist’, and may be indicated per SSB or CSI-RS.

At 1306, the method 1300 may include transmitting, to the UE, at least one of a RSRP threshold for SSB or a RSRP threshold for CSI-RS.

The method 1300 may be variously embodied, extended, or adapted, as described elsewhere in this description.

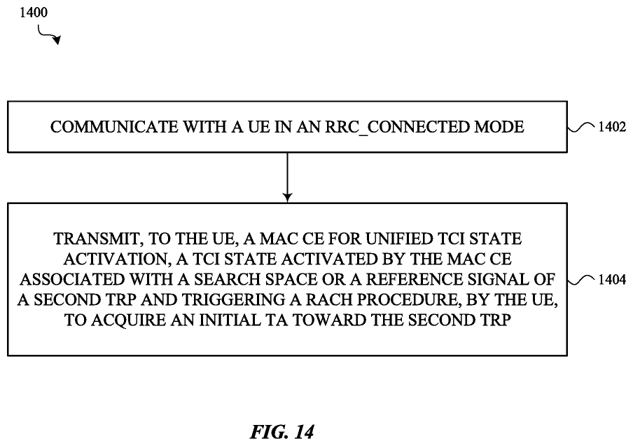

FIG. 14 shows a third example method 1400 of wireless communication by a base station. The method 1400 may be performed by the first TRP described with reference to FIG. 1 or by other TRPs described herein. The method 1400 may be performed using a processor, a set of transceivers (e.g., one or more transceivers), or other components of a base station.

At 1402, the method 1400 may include communicating with a UE in an RRC_CONNECTED mode.

At 1404, the method 1400 may include transmitting, to the UE, a MAC CE for unified TCI state activation. A TCI state activated by the MAC CE may be associated with a search space or a reference signal of a second TRP, and may trigger a RACH procedure, by the UE, to acquire an initial TA toward the second TRP.

The method 1400 may be variously embodied, extended, or adapted, as described elsewhere in this description.

Embodiments contemplated herein include an apparatus having means to perform one or more elements of the method 200, 600, 700, 1200, 1300, or 1400. In the context of method 200, 600, or 700, the apparatus may be, for example, an apparatus of a UE (such as a wireless device 1602 that is a UE, as described herein). In the context of method 1200, 1300, or 1400, the apparatus may be, for example, an apparatus of a base station (such as a network device 1620 that is a base station, as described herein).

Embodiments contemplated herein include one or more non-transitory computer-readable media storing instructions to cause an electronic device, upon execution of the instructions by one or more processors of the electronic device, to perform one or more elements of the method 200, 600, 700, 1200, 1300, or 1400. In the context of method 200, 600, or 700, the non-transitory computer-readable media may be, for example, a memory of a UE (such as a memory 1606 of a wireless device 1602 that is a UE, as described herein). In the context of method 1200, 1300, or 1400, the non-transitory computer-readable media may be, for example, a memory of a base station (such as a memory 1624 of a network device 1620 that is a base station, as described herein).

Embodiments contemplated herein include an apparatus having logic, modules, or circuitry to perform one or more elements of the method 200, 600, 700, 1200, 1300, or 1400. In the context of method 200, 600, or 700, the apparatus may be, for example, an apparatus of a UE (such as a wireless device 1602 that is a UE, as described herein). In the context of method 1200, 1300, or 1400, the apparatus may be, for example, an apparatus of a base station (such as a network device 1620 that is a base station, as described herein).

Embodiments contemplated herein include an apparatus having one or more processors and one or more computer-readable media, using or storing instructions that, when executed by the one or more processors, cause the one or more processors to perform one or more elements of the method 200, 600, 700, 1200, 1300, or 1400. In the context of method 200, 600, or 700, the apparatus may be, for example, an apparatus of a UE (such as a wireless device 1602 that is a UE, as described herein). In the context of the method 1200, 1300, or 1400, the apparatus may be, for example, an apparatus of a base station (such as a network device 1620 that is a base station, as described herein).

Embodiments contemplated herein include a signal as described in or related to one or more elements of the method 200, 600, 700, 1200, 1300, or 1400.

Embodiments contemplated herein include a computer program or computer program product having instructions, wherein execution of the program by a processor causes the processor to carry out one or more elements of the method 200, 600, 700, 1200, 1300, or 1400. In the context of method 200, 600, or 700, the processor may be a processor of a UE (such as a processor(s) 1604 of a wireless device 1602 that is a UE, as described herein), and the instructions may be, for example, located in the processor and/or on a memory of the UE (such as a memory 1606 of a wireless device 1602 that is a UE, as described herein). In the context of method 1200, 1300, or 1400, the processor may be a processor of a base station (such as a processor(s) 1622 of a network device 1620 that is a base station, as described herein), and the instructions may be, for example, located in the processor and/or on a memory of the base station (such as a memory 1624 of a network device 1620 that is a base station, as described herein).

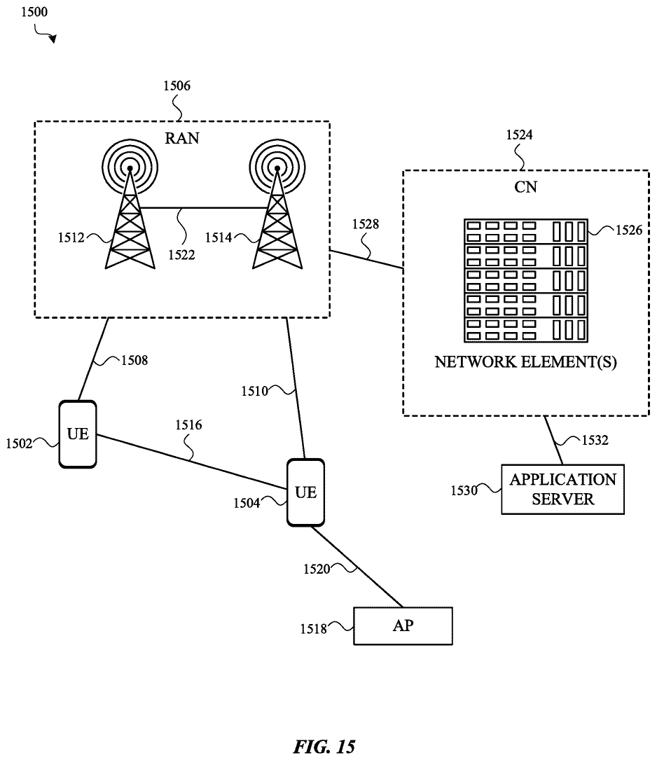

FIG. 15 illustrates an example architecture of a wireless communication system 1500, according to embodiments disclosed herein. The following description is provided for an example wireless communication system 1500 that operates in conjunction with the LTE system standards and/or 5G or NR system standards as provided by 3GPP technical specifications.

As shown by FIG. 15, the wireless communication system 1500 includes UE 1502 and UE 1504 (although any number of UEs may be used). In this example, the UE 1502 and the UE 1504 are illustrated as smartphones (e.g., handheld touchscreen mobile computing devices connectable to one or more cellular networks), but may also comprise any mobile or non-mobile computing device configured for wireless communication.

The UE 1502 and UE 1504 may be configured to communicatively couple with a RAN 1506. In embodiments, the RAN 1506 may be NG-RAN, E-UTRAN, etc. The UE 1502 and UE 1504 utilize connections (or channels) (shown as connection 1508 and connection 1510, respectively) with the RAN 1506, each of which comprises a physical communications interface. The RAN 1506 can include one or more base stations, such as base station 1512 and base station 1514, that enable the connection 1508 and connection 1510.

In this example, the connection 1508 and connection 1510 are air interfaces to enable such communicative coupling, and may be consistent with RAT(s) used by the RAN 1506, such as, for example, an LTE and/or NR.

In some embodiments, the UE 1502 and UE 1504 may also directly exchange communication data via a sidelink interface 1516. The UE 1504 is shown to be configured to access an access point (shown as AP 1518) via connection 1520. By way of example, the connection 1520 can comprise a local wireless connection, such as a connection consistent with any IEEE 802.11 protocol, wherein the AP 1518 may comprise a Wi-Fi® router. In this example, the AP 1518 may be connected to another network (for example, the Internet) without going through a CN 1524.

In embodiments, the UE 1502 and UE 1504 can be configured to communicate using orthogonal frequency division multiplexing (OFDM) communication signals with each other or with the base station 1512 and/or the base station 1514 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1512 or base station 1514 may be implemented as one or more software entities running on server computers as part of a virtual network. In addition, or in other embodiments, the base station 1512 or base station 1514 may be configured to communicate with one another via interface 1522. In embodiments where the wireless communication system 1500 is an LTE system (e.g., when the CN 1524 is an EPC), the interface 1522 may be an X2 interface. The X2 interface may be defined between two or more base stations (e.g., two or more eNBs and the like) that connect to an EPC, and/or between two eNBs connecting to the EPC. In embodiments where the wireless communication system 1500 is an NR system (e.g., when CN 1524 is a 5GC), the interface 1522 may be an Xn interface. The Xn interface is defined between two or more base stations (e.g., two or more gNBs and the like) that connect to 5GC, between a base station 1512 (e.g., a gNB) connecting to 5GC and an eNB, and/or between two eNBs connecting to 5GC (e.g., CN 1524).

The RAN 1506 is shown to be communicatively coupled to the CN 1524. The CN 1524 may comprise one or more network elements 1526, which are configured to offer various data and telecommunications services to customers/subscribers (e.g., users of UE 1502 and UE 1504) who are connected to the CN 1524 via the RAN 1506. The components of the CN 1524 may be implemented in one physical device or separate physical devices including components to read and execute instructions from a machine-readable or computer-readable medium (e.g., a non-transitory machine-readable storage medium).

In embodiments, the CN 1524 may be an EPC, and the RAN 1506 may be connected with the CN 1524 via an S1 interface 1528. In embodiments, the S1 interface 1528 may be split into two parts, an S1 user plane (S1-U) interface, which carries traffic data between the base station 1512 or base station 1514 and a serving gateway (S-GW), and the S1-MME interface, which is a signaling interface between the base station 1512 or base station 1514 and mobility management entities (MMEs).

In embodiments, the CN 1524 may be a 5GC, and the RAN 1506 may be connected with the CN 1524 via an NG interface 1528. In embodiments, the NG interface 1528 may be split into two parts, an NG user plane (NG-U) interface, which carries traffic data between the base station 1512 or base station 1514 and a user plane function (UPF), and the S1 control plane (NG-C) interface, which is a signaling interface between the base station 1512 or base station 1514 and access and mobility management functions (AMFs).

Generally, an application server 1530 may be an element offering applications that use internet protocol (IP) bearer resources with the CN 1524 (e.g., packet switched data services). The application server 1530 can also be configured to support one or more communication services (e.g., VoIP sessions, group communication sessions, etc.) for the UE 1502 and UE 1504 via the CN 1524. The application server 1530 may communicate with the CN 1524 through an IP communications interface 1532.

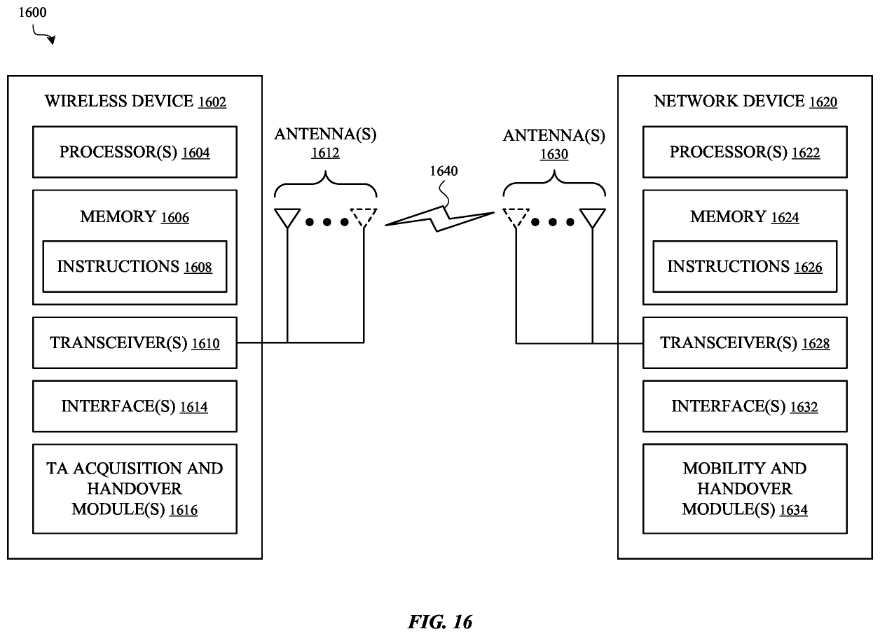

FIG. 16 illustrates a system 1600 for performing signaling 1640 between a wireless device 1602 and a network device 1620, according to embodiments disclosed herein. The system 1600 may be a portion of a wireless communication system as herein described. The wireless device 1602 may be, for example, a UE of a wireless communication system. The network device 1620 may be, for example, a base station (e.g., an eNB or a gNB) of a wireless communication system.

The wireless device 1602 may include one or more processor(s) 1604. The processor(s) 1604 may execute instructions such that various operations of the wireless device 1602 are performed, as described herein. The processor(s) 1604 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1602 may include a memory 1606. The memory 1606 may be a non-transitory computer-readable storage medium that stores instructions 1608 (which may include, for example, the instructions being executed by the processor(s) 1604). The instructions 1608 may also be referred to as program code or a computer program. The memory 1606 may also store data used by, and results computed by, the processor(s) 1604.

The wireless device 1602 may include one or more transceiver(s) 1610 that may include radio frequency (RF) transmitter and/or receiver circuitry that use the antenna(s) 1612 of the wireless device 1602 to facilitate signaling (e.g., the signaling 1640) to and/or from the wireless device 1602 with other devices (e.g., the network device 1620) according to corresponding RATs.

The wireless device 1602 may include one or more antenna(s) 1612 (e.g., one, two, four, or more). For embodiments with multiple antenna(s) 1612, the wireless device 1602 may leverage the spatial diversity of such multiple antenna(s) 1612 to send and/or receive multiple different data streams on the same time and frequency resources. This behavior may be referred to as, for example, MIMO behavior (referring to the multiple antennas used at each of a transmitting device and a receiving device that enable this aspect). MIMO transmissions by the wireless device 1602 may be accomplished according to precoding (or digital beamforming) that is applied at the wireless device 1602 that multiplexes the data streams across the antenna(s) 1612 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1602 may implement analog beamforming techniques, whereby phases of the signals sent by the antenna(s) 1612 are relatively adjusted such that the (joint) transmission of the antenna(s) 1612 can be directed (this is sometimes referred to as beam steering).

The wireless device 1602 may include one or more interface(s) 1614. The interface(s) 1614 may be used to provide input to or output from the wireless device 1602. For example, a wireless device 1602 that is a UE may include interface(s) 1614 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1610/antenna(s) 1612 already described) that allow for communication between the UE and other devices and may operate according to known protocols (e.g., Wi-Fi®, Bluetooth®, and the like).

The wireless device 1602 may include one or more TA acquisition and handover module(s) 1616. The TA acquisition and handover module(s) 1616 may be implemented via hardware, software, or combinations thereof. For example, the TA acquisition and handover module(s) 1616 may be implemented as a processor, circuit, and/or instructions 1608 stored in the memory 1606 and executed by the processor(s) 1604. In some examples, the TA acquisition and handover module(s) 1616 may be integrated within the processor(s) 1604 and/or the transceiver(s) 1610. For example, the TA acquisition and handover module(s) 1616 may be implemented by a combination of software components (e.g., executed by a DSP or a general processor) and hardware components (e.g., logic gates and circuitry) within the processor(s) 1604 or the transceiver(s) 1610.

The TA acquisition and handover module(s) 1616 may be used for various aspects of the present disclosure, for example, aspects of FIGS. 1-14. The TA acquisition and handover module(s) 1616 may be configured to, for example, acquire an initial TA for a TRP, receive pre-configurations for target candidate cells, or receive L1/L2 handover trigger commands.

The network device 1620 may include one or more processor(s) 1622. The processor(s) 1622 may execute instructions such that various operations of the network device 1620 are performed, as described herein. The processor(s) 1622 may include one or more baseband processors implemented using, for example, a CPU, a DSP, an ASIC, a controller, an FPGA device, another hardware device, a firmware device, or any combination thereof configured to perform the operations described herein.

The network device 1620 may include a memory 1624. The memory 1624 may be a non-transitory computer-readable storage medium that stores instructions 1626 (which may include, for example, the instructions being executed by the processor(s) 1622). The instructions 1626 may also be referred to as program code or a computer program. The memory 1624 may also store data used by, and results computed by, the processor(s) 1622.

The network device 1620 may include one or more transceiver(s) 1628 that may include RF transmitter and/or receiver circuitry that use the antenna(s) 1630 of the network device 1620 to facilitate signaling (e.g., the signaling 1640) to and/or from the network device 1620 with other devices (e.g., the wireless device 1602) according to corresponding RATs.

The network device 1620 may include one or more antenna(s) 1630 (e.g., one, two, four, or more). In embodiments having multiple antenna(s) 1630, the network device 1620 may perform MIMO, digital beamforming, analog beamforming, beam steering, etc., as has been described.

The network device 1620 may include one or more interface(s) 1632. The interface(s) 1632 may be used to provide input to or output from the network device 1620. For example, a network device 1620 that is a base station may include interface(s) 1632 made up of transmitters, receivers, and other circuitry (e.g., other than the transceiver(s) 1628/antenna(s) 1630 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1620 may include one or more mobility and handover module(s) 1634. The mobility and handover module(s) 1634 may be implemented via hardware, software, or combinations thereof. For example, the mobility and handover module(s) 1634 may be implemented as a processor, circuit, and/or instructions 1626 stored in the memory 1624 and executed by the processor(s) 1622. In some examples, the mobility and handover module(s) 1634 may be integrated within the processor(s) 1622 and/or the transceiver(s) 1628. For example, the mobility and handover module(s) 1634 may be implemented by a combination of software components (e.g., executed by a DSP or a general processor) and hardware components (e.g., logic gates and circuitry) within the processor(s) 1622 or the transceiver(s) 1628.

The mobility and handover module(s) 1634 may be used for various aspects of the present disclosure, for example, aspects of FIGS. 1-14. The mobility and handover module(s) 1634 may be configured to, for example, configure a RACH procedure for the wireless device 1602, transmit pre-configurations for target candidate cells for the wireless device 1602, or transmit L1/L2 handover trigger commands to the wireless device 1602.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

What is claimed is:

1. A user equipment (UE), comprising:
a set of transceivers; and
a processor configured to,
operate the UE in an RRC_CONNECTED mode with a first transmission and reception point (TRP);
receive, via the set of transceivers, a physical downlink control channel (PDCCH) order in a search space set associated with at least one of the first TRP or a second TRP;
determine, in response to information indicated by the PDCCH order, a physical random access channel (PRACH) resource to be used for a random access channel (RACH) procedure with the second TRP; and
transmit, via the set of transceivers, a RACH preamble on the PRACH resource to acquire an initial timing advance (TA) toward the second TRP.

2. The UE of claim 1, wherein:
the first TRP and the second TRP share a physical cell ID (PCI);
the search space set in which the PDCCH order is received is associated with the first TRP; and
the information indicated by the PDCCH order includes a synchronization signal block (SSB) index and a random access (RA) preamble index that is associated with an SSB identified by the SSB index.

3. The UE of claim 2, wherein:
the PRACH resource is used for a contention-based random access (CBRA) procedure;
the processor is configured to,
receive, via the set of transceivers,
a number of SSBs associated with the first TRP and the second TRP for each PRACH occasion; and
a number of contention-based preambles per SSB;
the SSB index identifies an SSB in the number of SSBs; and
the RA preamble index identifies a contention-based preamble of the number of contention-based preambles per SSB identified by the SSB index.

4. The UE of claim 2, wherein:
the PRACH resource is used for a contention-free random access (CFRA) procedure; and
the processor is configured to,
receive, via the set of transceivers,
a number of SSBs associated with the first TRP and the second TRP for each PRACH occasion; and
a number of contention-based preambles per SSB; and
dynamically select the PRACH resource in response to the information indicated by the PDCCH order.

5. The UE of claim 1, wherein:
the first TRP and the second TRP are associated with different physical cell IDs (PCIs);
the search space set in which the PDCCH order is received is associated with the first TRP; and
the information indicated by the PDCCH order identifies the second TRP as a TRP associated with a triggered RACH procedure.

6. The UE of claim 5, wherein the processor is configured to receive, via the set of transceivers, from the first TRP, and before receiving the PDCCH order, a PRACH resource configuration of each non-serving cell in an ‘additionalPCIlist’, where each non-serving cell in the ‘additionalPCIlist’ is configured with an ‘additional PCI’ index in the ‘additionalPCIlist’.

7. The UE of claim 5, wherein the PDCCH order includes a set of fields, the set of fields includes a one-bit field that identifies a non-serving cell associated with the second TRP, and the non-serving cell is associated with a set of active transmission configuration indicator (TCI) states for the second TRP.

8. The UE of claim 5, wherein the PDCCH order includes a set of fields, the set of fields including a three-bit field that identifies a non-serving cell associated with the second TRP, the three-bit field indicates an ‘additional PCI’ index value that identifies a non-serving cell from a set of non-serving cells for the second TRP.

9. The UE of claim 8, wherein:
the set of non-serving cells is configured by radio resource control (RRC) signaling;
a first non-serving cell of the set of non-serving cells is associated with a set of active transmission configuration indicator (TCI) states; and
at least a second non-serving cell of the set of non-serving cells is not associated with the set of active TCI states.

10. The UE of claim 1, wherein the RACH procedure is a contention-free random access (CFRA) procedure or a contention-based random access (CBRA) procedure that is triggered by the PDCCH order.

11. The UE of claim 1, wherein the search space set is associated with ‘coresetPoolIndex=0’.

12. The UE of claim 1, wherein:
the search space set is associated with the second TRP; and
the information indicated by the PDCCH order includes a synchronization signal block (SSB) index and a random access (RA) preamble index that is associated with an SSB identified by the SSB index.

13. The UE of claim 12, wherein:
the processor is configured to,
receive, via the set of transceivers, from the first TRP, and before receiving the PDCCH order, and for each non-serving cell that is configured in an ‘additionalPCIlist’,
a Type1-PDCCH common search space (CSS) set configuration; and
a random access response (RAR) window configuration; and
after transmitting the RACH preamble, monitor a Type1-PDCCH CSS set associated with the second TRP for a RAR, in accordance with a Type1-PDCCH CSS set configuration for the second TRP, and in accordance with a RAR window configuration for the second TRP.

14. The UE of claim 1, wherein:
the processor is configured to receive, from the first TRP and before receiving a handover command targeting a non-serving cell included in an ‘additionalPCIlist’,
the ‘additionalPCIlist’; and
a radio resource control (RRC) configuration of each non-serving cell included in the ‘additionalPCIlist’.

15. The UE of claim 1, wherein:
the processor is configured to receive, via the set of transceivers, from the first TRP, and before receiving a handover command targeting a non-serving cell, a radio resource control (RRC) configuration including,
a list of cell groups; and
for each cell group of the list of cell groups,
a configuration of a target candidate cell for layer 1/layer 2 (L1/L2)-based handover; and
an indicator of the target candidate cell.

16. The UE of claim 1, wherein the processor is configured to receive, from the first TRP, a medium access control (MAC) control element (CE) (MAC CE) that triggers a layer 1/layer 2 (L1/L2) based handover to a target cell, the MAC CE including a physical cell ID (PCI) or cell group ID (CG-ID) associated with the target cell.

17. The UE of claim 1, wherein:
the processor is configured to receive, via the set of transceivers and from the first TRP, downlink control information (DCI) having a format that includes,
an additional physical cell ID (PCI) or cell group ID (CG-ID) field; and
a handover trigger field, the handover trigger field indicating whether one or both of a layer 1/layer 2 (L1/L2) based handover or the RACH procedure is triggered for a PCI or CG-ID identified in the additional PCI or CG-ID field.

18. A user equipment (UE), comprising:
a set of transceivers; and
a processor configured to,
operate the UE in an RRC_CONNECTED mode with a first transmission and reception point (TRP);
receive, via the set of transceivers, from the first TRP, and for a second TRP that is configured in an ‘additionalPCIlist’, an indication of a set of one or more physical random access channel (PRACH) resources per synchronization signal block (SSB) or channel state information reference signal (CSI-RS);
receive, via the set of transceivers and from the first TRP, at least one of a reference signal received power (RSRP) threshold for SSB or a RSRP threshold for CSI-RS;
in response to determining at least one of the RSRP threshold for SSB or the RSRP threshold for CSI-RS is met, determine, using the indication of the set of one or more PRACH resources, a PRACH resource to be used for a random access channel (RACH) procedure with the second TRP; and
transmit, via the set of transceivers, a RACH preamble on the PRACH resource to acquire an initial timing advance (TA) toward the second TRP.

19. The UE of claim 18, wherein:
the processor is configured to,
receive, via the set of transceivers, from the first TRP, and for the second TRP,
a Type1-physical downlink control channel (PDCCH) common search space (CSS) set configuration; and
a random access response (RAR) window configuration; and
after transmitting the RACH preamble, monitor a Type1-PDCCH CSS set in accordance with the Type1-PDCCH CSS set configuration, and in accordance with the RAR window configuration.

20. A user equipment (UE), comprising:
a set of transceivers; and
a processor configured to,
operate the UE in an RRC_CONNECTED mode with a first transmission and reception point (TRP);
receive, via the set of transceivers and from the first TRP, a medium access control (MAC) control element (CE) (MAC CE) for unified transmission configuration indicator (TCI) state activation;
in response to determining that a TCI state activated by the MAC CE is associated with a search space or a reference signal of a second TRP, trigger a random access channel (RACH) procedure to acquire an initial timing advance (TA) toward the second TRP.
